(19) United States
(12) Patent Application Publication
(10) Pub. No.: US 2026/0048665 A1
(43) Pub. Date: Feb. 19, 2026

(54) BATTERY CHARGING AND DISCHARGING OPERATION METHOD IN DUAL BATTERY SYSTEM AND SYSTEM FOR THE SAME

(71) Applicants: Hyundai Motor Company, Seoul (KR); Kia Corporation, Seoul (KR)

(72) Inventors: Dae Won YANG, Hwaseong-Si (KR); Gi Young KWON, Hwaseong-Si (KR); Min Su KIM, Hwaseong-Si (KR)

(21) Appl. No.: 19/185,098

(22) Filed: Apr. 21, 2025

(30) Foreign Application Priority Data
Aug. 19, 2024 (KR) 10-2024-0110371

(51) Int. Cl. B60L 7/16; B60L 50/60; B60L 58/20

(52) U.S. Cl. CPC B60L 7/16; B60L 50/60; B60L 58/20; B60L 2210/10; B60L 2210/40; B60L 2240/62; B60L 2240/642; B60L 2260/26; B60L 2260/54

(57) ABSTRACT

Battery management in a dual battery system may be achieved by a battery charging and discharging operation method and a system therefor. The method may, given an uphill section and a downhill section on a driving route to a destination in navigation information, calculate/determine an estimated charge amount by regenerative braking that may be acquired from the downhill section; determine whether to drive uphill only with a main high-voltage battery based on the estimated charge amount; and when driving uphill only with the main high-voltage battery, transfer, only to the main high-voltage battery, a charging path by the regenerative braking acquired from the downhill section, thereby reducing a system loss that may be caused by charge/discharge of a sub high-voltage battery.

### CROSS-REFERENCE TO RELATED APPLICATION

This application claims the benefit of Korean Patent Application No. 10-2024-0110371, filed on Aug. 19, 2024, which is hereby incorporated by reference as if fully set forth herein.

### TECHNICAL FIELD

The present disclosure relates to battery management in a dual battery system and, more particularly, to a battery charging/discharging operation method in a dual battery system and a system therefor, based on an uphill section and a downhill section in navigation information.

### BACKGROUND

In general, an electrical system of an electric vehicle (EV) and/or a plug-in hybrid electric vehicle (PHEV) may include a motor system 14 including a motor 14a configured to generate a driving force and an inverter 14b configured to drive the motor 14a, a main high-voltage battery 11 used as a power source for the motor 14a, a high-voltage junction box (HV J/BOX) 12 configured to distribute and supply a high voltage supplied from the main high-voltage battery 11, and a battery management control unit 13 (e.g., a computing device and/or controller) configured to control a voltage distribution process of the HV J/BOX 12 and manage a state of the main high-voltage battery 11, as shown in FIG. 1.

A power control unit 15 (e.g., a computing device and/or controller) may be configured to perform overall control of the motor-driven electrical system configured as described above.

This motor-driven electrical system configured as described above is typical of a current second-generation electric vehicle.

The second-generation electric vehicle described above refers to an electric vehicle capable of traveling more than 400 kilometers (km) after a single full charge of the main high-voltage battery 11, which improves upon first-generation electric vehicles that have a driving range of about 200 km after the single full charge. However, the improved battery performance/driving range may not fully satisfy the needs of consumers.

A dual battery system may further improve battery performance/driving range. FIG. 2 shows such a dual battery system, in which a sub high-voltage battery 17 is added to a power system as in FIG. 1.

The main high-voltage battery 11 and the sub high-voltage battery 17 may have differences in terms of capacity and/or capability (e.g., performance). For example, the main high-voltage battery 11 may have a first capability (e.g., 123 kilowatt-hours (kWh) (697 volts)), and the sub high-voltage battery 17 may have a second capability less than the first capability (e.g., 30 kWh (174 volts)). For example, the second capability may be a fraction of (e.g., about 20% to 25%) the first capability. However, examples are not limited thereto.

A converter such as a high-voltage matching unit 16 (e.g., a high-voltage direct current to direct current (DC-DC) converter (HDC)) may be provided (e.g., as shown in FIG. 2) to match a voltage of the main high-voltage battery 11 and a voltage of the sub high-voltage battery 17.

A power control unit 19 (e.g., controller and/or computing device) may be configured to perform overall control on the electrical system configured of FIG. 2. A battery management control unit 18 (e.g., battery management controller and/or computing device) may be configured to manage the states of the main high-voltage battery 11 and the sub high-voltage battery 17. The power control unit 19 and the battery management control unit 18 may be implemented in the same or separate computing devices.

The sub high-voltage battery 17 may be configured for use to charge the main high-voltage battery 11 and/or performs functions as an auxiliary power source to drive the motor 14a.

Although the dual battery system described herein aims to achieve an improved driving range through the main high-voltage battery 11 and the sub high-voltage battery 17, existing battery control methods, e.g., for a single battery system as in FIG. 1, may not be suitable for a vehicle with the dual battery system.

As an example, as shown in FIG. 3, according to an existing battery control method, the main high-voltage battery 11 and the sub high-voltage battery 17 may be discharged evenly in an uphill section, and the main high-voltage battery 11 and the sub high-voltage battery 17 may be charged evenly in an downhill section (e.g., that is a regenerative braking-based charging section), with the goal to keep state of charge (SOC) values of the main high-voltage battery 11 and the sub high-voltage battery 17 uniform.

However, if a charging and discharging process of the sub high-voltage battery 17 is performed frequently, a problem may arise that the loss of the high voltage matching unit 16 increases.

### SUMMARY

The following summary presents a simplified summary of certain features. The summary is not an extensive overview and is not intended to identify key or critical elements.

Systems, apparatuses, and methods are described for battery charging and/or discharging in a dual battery system. A method may be performed by a dual battery system of a vehicle, the method comprising: receiving, from a navigation system of the vehicle, information indicating a driving route and one or more of a road condition of the driving route, geographic information of the driving route, or environmental information of the driving route; detecting, in the driving route, an uphill section and a downhill section; determining an estimated consumption energy, of a motor of the vehicle, for the uphill section, determining an estimated regenerative energy, from regenerative braking of the vehicle, for the downhill section; selecting, based on the estimated consumption energy and the estimated regenerative energy, at least one battery of a main battery of the vehicle or a sub battery of the vehicle for driving the vehicle in the uphill section and the downhill section; and controlling charging or discharging of the selected at least one battery during driving of the vehicle in the uphill section and the downhill section.

A system for a vehicle may comprise: a motor system comprising a motor and circuitry configured to receive power to drive the motor; a main battery configured to selectively supply power to the motor system; a sub battery configured to selectively supply power to the motor system; a navigation system configured to provide information indicating a driving route and one or more of a road condition of the driving route, geographic information of the driving route, or environmental information of the driving route; a power controller configured to control, based on a control signal, a charging and discharging path of the main battery and the sub battery; and a battery management controller. The battery management controller may be configured to acquire information of the navigation system, information of the main battery, and information of the sub battery, and to provide the control signal to the power controller. The battery management controller may be configured to: detect, in the driving route, an uphill section and a downhill section; determine an estimated consumption energy for the detected uphill section; determine an estimated regenerative energy for the downhill section; select, based on the estimated consumption energy and the estimated regenerative energy, at least one battery of the main battery or the sub battery for driving the vehicle in the uphill section and the downhill section; and control charging or discharging of the selected at least one battery during driving of the vehicle in the uphill section or the downhill section.

A vehicle may comprise: a motor; circuitry configured to receive power to drive the motor; a main battery configured to selectively supply power to the motor; a sub battery configured to selectively supply power to the motor; a navigation system configured acquire a driving route for the vehicle; a power controller configured to control, charging or discharging of the main battery or the sub battery; and a battery management controller. The battery management controller may be configured to: receive, from the navigation system, the driving route, determine, based on an uphill section and a downhill section detected in the driving route: an estimated consumption energy for the uphill section, and an estimated regenerative energy for the downhill section; select, based on the estimated consumption energy and the estimated regenerative energy, the main battery or the sub battery; and send, to the power controller, a control signal configured to control charging and discharging of the select battery during driving of the vehicle on the uphill section and the downhill section.

These and other features and advantages are described in greater detail below.

### BRIEF DESCRIPTION OF THE DRAWINGS

FIG. 1 is a block diagram illustrating an example of an electrical system of a typical electric vehicle.

FIG. 2 is a block diagram illustrating an example configuration of a dual battery system equipped with a sub high-voltage battery according to an example.

FIG. 3 is a diagram illustrating an example of a battery charging and discharging path in an uphill section and a downhill section in a typical vehicle with a dual battery system.

FIG. 4 is a block diagram illustrating an example of a battery charging and discharging operation system in a dual battery system according to an example.

FIG. 5 is a block diagram illustrating a battery management system (or a “battery management control unit” herein) shown in FIG. 4.

FIGS. 6 and 7 are weight tables used in the battery management system (or the battery management control unit) shown in FIG. 5

FIG. 8 is a diagram illustrating an example of a battery usage mode generated by the battery management system (or the battery management control unit) shown in FIG. 5

FIG. 9 is a block diagram illustrating another example of a dual battery system with a battery charging and discharging operation system according to an example.

FIGS. 10, 11, and 12 are flowcharts illustrating operations of a battery charging and discharging operation system according to an example.

FIG. 13 is a diagram illustrating an example of a battery charging and discharging path in an uphill section and a downhill section in a vehicle with a battery charging and discharging operation system, which corresponds to the example shown in FIG. 3, according to an example.

FIG. 14 is a flowchart illustrating a process of calculating estimated energy.

FIG. 15 is a diagram illustrating an example of a battery charging and discharging operation system applied to a dual battery system in a road situation and a downhill situation according to an example.

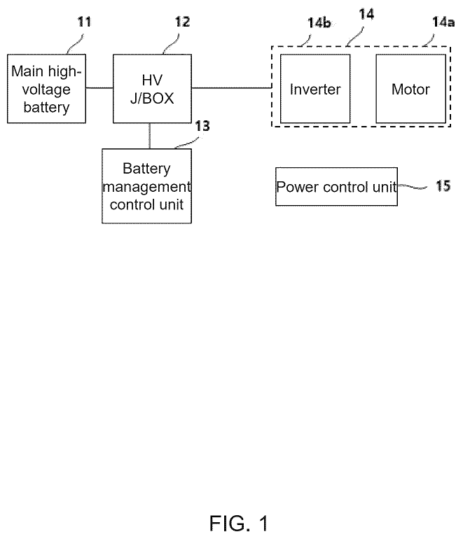

### DETAILED DESCRIPTION OF THE DISCLOSURE

Hereinafter, examples of the present disclosure will be described in detail with reference to the accompanying drawings. The examples are not construed as limited to the disclosure and should be understood to include all changes, equivalents, and replacements within the idea and the technical scope of the disclosure.

The terms “module,” “unit,” and/or “-er/or” for referring to elements are assigned and used interchangeably in consideration of the ease of explanation, and thus the terms per se do not necessarily have different meanings or functions. The terms “module,” “unit,” and/or “-er/or” do not necessarily require physical separation or distinct devices (e.g., they may be implemented/embodied in the same and/or separate devices).

Although terms including ordinal numbers, such as, “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases of, for example, “A,” “B,” and “A and B.” For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” may be used interchangeably with “at least one of”.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit,” “control unit,” “control device,” or “controller” is merely a widely used term for naming an element that controls a specific function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, computation, decision, and the like that are necessary for controlling a function assigned thereto.

Also, or additionally, throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

Meanwhile, a processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

In addition, computer-readable recording media (or simply memory) include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Hereinafter, a battery charging and discharging operation method in a dual battery system and a system therefor, according to examples of the present disclosure, will be described with reference to the accompanying drawings.

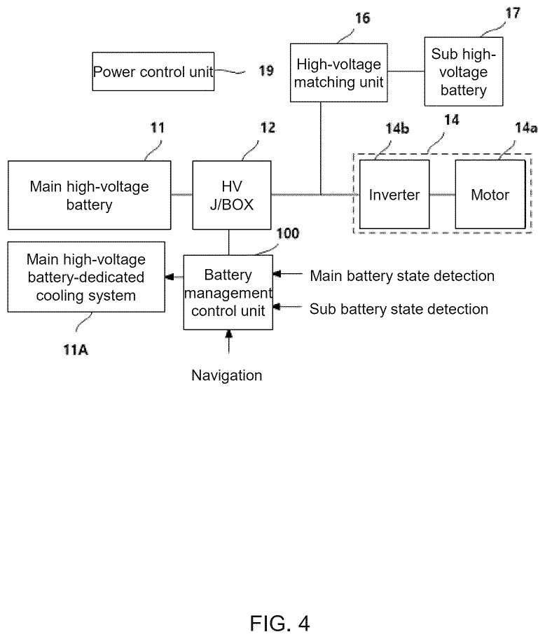

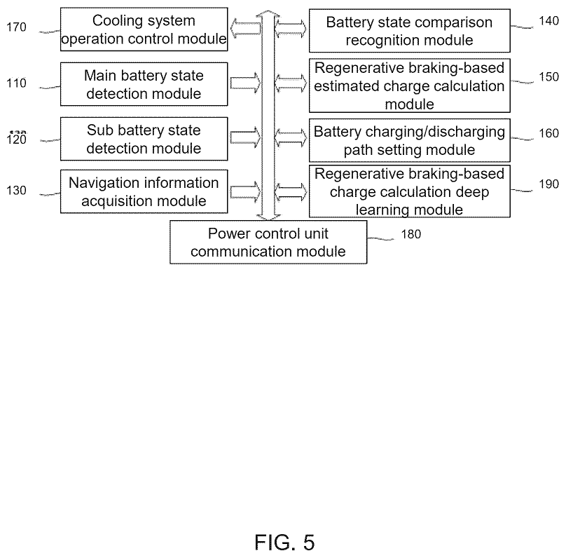

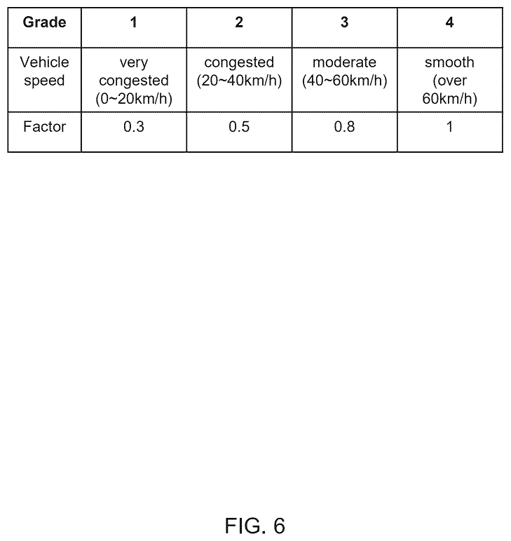

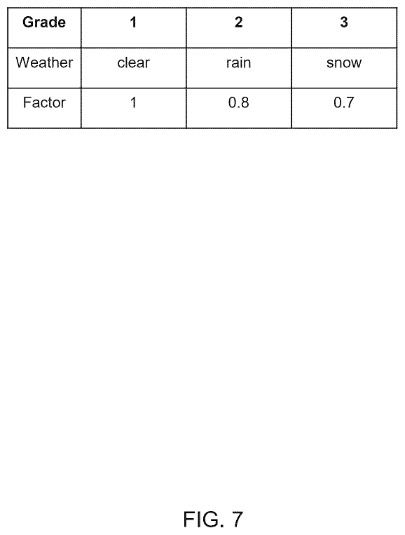

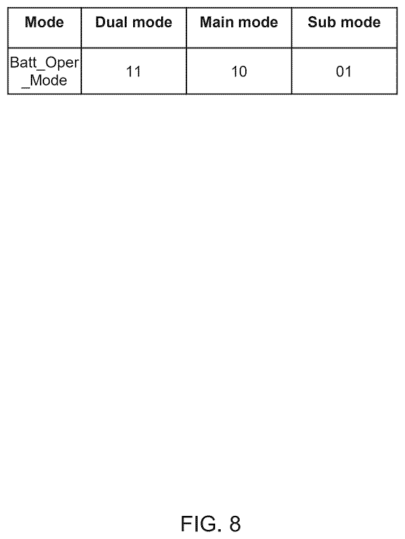

FIG. 4 is a block diagram illustrating an example of a battery charging and discharging operation system in a dual battery system, according to an example. FIG. 5 is a block diagram illustrating a battery management system (e.g., a “battery management control unit” herein) shown in FIG. 4. FIGS. 6 and 7 show example weight tables used in the battery management system (e.g., the battery management control unit 100) shown in FIG. 5. FIG. 8 is a diagram illustrating an example of a battery usage mode generated by the battery management system (or the battery management control unit) shown in FIG. 5.

A battery charging and discharging operation system associated with a dual battery system, according to an example of the present disclosure, may include, as shown in FIG. 4, a motor system 14 (e.g., including a motor 14a configured to generate a driving force and an inverter 14b configured to drive the motor 14a), a main high-voltage battery 11 (e.g., for use as a power source for the motor 14a), a high-voltage junction box (HV J/BOX) 12 (e.g., configured to distribute and/or supply a high voltage from the main high-voltage battery 11 to the motor system and/or auxiliary system(s) (not shown)), a main high-voltage battery-dedicated cooling system 11A (e.g., configured to maintain a constant temperature of the main high-voltage battery 11 based on an input control signal), a sub high-voltage battery 17 (e.g., provided as a power source separate from the main high-voltage battery 11), a converter such as a high voltage matching unit 16 (e.g., a high-voltage direct current to direct current (DC-DC) converter (HDC), configured to match a voltage of the main high-voltage battery 11 and a voltage of the sub high-voltage battery 17), and/or a battery management control unit 100 (e.g., configured to control a voltage distribution process of the HV J/BOX 12 and/or manage a state of the main high-voltage battery 11 and a state of the sub high-voltage battery 17).

The main high-voltage battery 11 and the sub high-voltage battery 17 may have differences in capacity and/or capability (e.g. performance).

For example, the main high-voltage battery 11 may have a first capability (e.g., of 123 kilowatt-hours (kWh) (697 volts)), the sub high-voltage battery 17 may have a second capability (e.g., of 30 kWh (174 volts)). The second capability may be less than the first capability (e.g., about 20% to 25% of the first capability). However, examples are not limited thereto and are solely for ease of discussion.

The battery management control unit 100 may receive information of a driving route (e.g., to a destination) from a navigation system (e.g., from a global positioning device (GPS) or other navigation/location aware device associated with the vehicle). If a condition is satisfied and the main high-voltage battery 11 is used (e.g., only the main high-voltage battery 11 is used), the battery management control unit 100 may control the main high-voltage battery-dedicated cooling system 11A to maintain a constant temperature of the main high-voltage battery 11 (e.g., to maintain a temperature within an acceptable range).

A power control unit 19 (e.g., controller and/or computing device) may be configured to perform overall control of an electrical system of a vehicle (e.g., configured as described herein).

Referring to FIG. 5, the battery management control unit 100 of the battery charging and/or discharging operation system in the dual battery system configured as described herein may include: a main battery state detection module 110 (e.g., configured to receive a state detection signal such as an operating state, an operating temperature, and/or a state of charge (SOC) generated by the main high-voltage battery 11 at a given (e.g., current) time point); a sub battery state detection module 120 (e.g., configured to receive a state detection signal such as an operating state, an operating temperature, and/or an SOC generated by the sub high-voltage battery 17 at a given (e.g., current) time point); a navigation information acquisition module 130 (e.g., configured to, in conjunction with the navigation system, acquire geographical information, such as including a uphill section and a downhill section on the driving route, a road condition such as a road congestion situation of an access road to the uphill section, and/or weather information); a battery state comparison recognition module 140 (e.g., configured to compare a battery state received via the main battery state detection module 110 and/or a battery state received via the sub battery state detection module 120); a regenerative braking-based estimated charge calculation module 150 (e.g., configured to estimate a charge amount that may be acquired by regenerative braking in the downhill section based on the information acquired via the navigation information acquisition module 130); a battery charging/discharging path setting module 160 (e.g., configured to set a charging/discharging path for the main high-voltage battery 11 and/or the sub high-voltage battery 17 in the uphill section based on the information acquired via the battery state comparison recognition module 140, the regenerative braking-based estimated charge calculation module 150, and/or the navigation information acquisition module 130); a power control unit communication module 180 (e.g., configured to transfer, to the power control unit 19, setting data on the charging/discharging path of the main high-voltage battery 11 and/or the sub high-voltage battery 17 set by the battery charging/discharging path setting module 160); a cooling system operation control module 170 (e.g., configured to control the main high-voltage battery-dedicated cooling system 11). A based on the setting data corresponding to when the charging/discharging path using only the main high-voltage battery 11 is set by the battery charging/discharging path setting module 160); and/or a regenerative braking-based charge amount calculation deep learning module 190 (e.g., configured to compare a regenerative braking-based estimated charge amount that is estimated by the regenerative braking-based estimated charge calculation module 150 and an actual charge amount in the future, and improve an estimated output efficiency of the regenerative braking-based charge calculation module 150).

Each of the modules may be implemented with a memory in which one or more instructions and/or a program for performing the corresponding functions is stored and a processor for executing the program. The respective memories of the modules may be integrated into one or more memories, and the respective processors thereof may be integrated into one or more processors.

The battery management control unit 100 may further comprise and/or be in communication with one or more sensors configured to provide various information disclosed herein. For example, the main battery state detection module 110 may comprise and/or be configured to communicate with one or more first sensors configured to detect the state of the main high-voltage battery 110 and/or a state signal generated by the main high-voltage battery 11, such as an operating state monitor/sensor configured to monitor/detect the operating state of the main high-voltage battery 11, a thermometer configured to detect the operating temperature of the main high-voltage battery 11, and/or an SOC sensor (e.g., voltmeter, ammeter, etc.) configured to detect the SOC of the main high-voltage battery 11. The sub battery state detection module 120 may comprise and/or be configured to communicate with one or more second sensors configured to detect the state of the sub high-voltage battery 17 and/or a state signal generated by the sub high-voltage battery 17, such as an operating state monitor configured to monitor the operating state of the sub high-voltage battery 17, a thermometer configured to detect the operating temperature of the sub high-voltage battery 17, and/or an SOC sensor (e.g., voltmeter, ammeter, etc.) configured to detect the SOC of the sub high-voltage battery 17. The navigation information acquisition module 130 may comprise and/or be in communication with one or more sensors such as a GPS device and/or other map/location aware devices configured to acquire/determine and/or provide geographical information and/or road conditions about the driving route, and/or other sensors configured to provide geographical/topographical information about the driving route (such as cameras/accelerometers/torque sensors configured to obtain/detect uphill/downhill sections of road and/or road conditions, etc.).

In the battery charging and discharging operation system in the dual battery system according to an example of the present disclosure, one or more weight variable(s) may be used to calculate the estimated charge amount by the regenerative braking-based estimated charge calculation module 150. The weight variable(s) may be based on road congestion information and/or weather information of the uphill section or the downhill section (e.g., as shown in example tables in FIGS. 6 and 7). For example, FIG. 6 shows example weights as “factors” corresponding to traffic congestion levels (e.g., as quantified by average speed range, relative to a legal speed limit of 60 km/h, for example). FIG. 7 shows example weights as “factors” corresponding to types of implement weather—the factors may be further differentiated by amount/degree of a given inclement weather (e.g., light rain or snow vs heavy rain or snow, measured by time/amount of each) and/or other factors may be given to other weather factors, such as temperature, fog, hail, iciness, wind, etc.). A total amount of energy required for the uphill section and an amount of regenerative braking energy that may be acquired in the downhill section may be estimated based on the weight variable(s).

Based on this estimation, the battery management control unit 100 may select a mode from among a main mode “10” (e.g., using only the main high-voltage battery 11), a sub-mode “01” (e.g., using only the sub high-voltage battery 17), and a dual mode “11” (e.g., using both the main high-voltage battery 11 and the sub high-voltage battery 17). The binary symbols “10”, “01”, “11” are solely for example, and other signals may be used to represent these modes. The selection may be made via/by the battery charging/discharging path setting module 160, as shown in FIG. 8. The battery management control unit 100 may transfer a result of this selection to the power control unit 19.

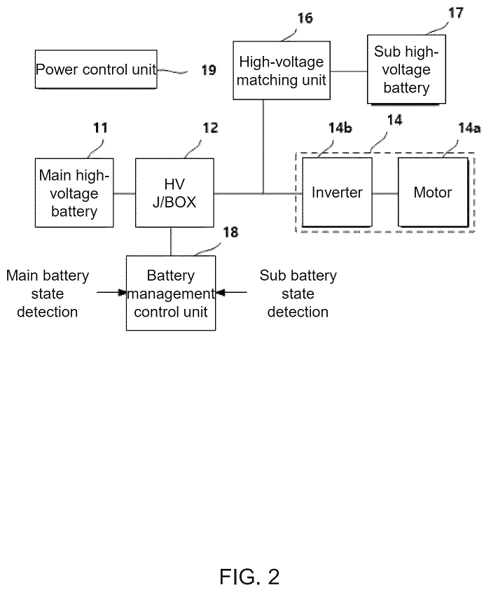

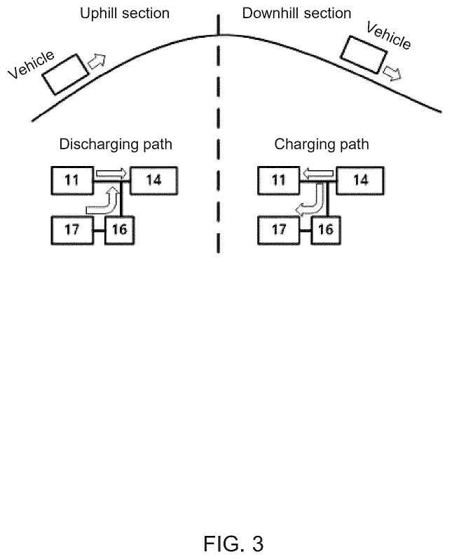

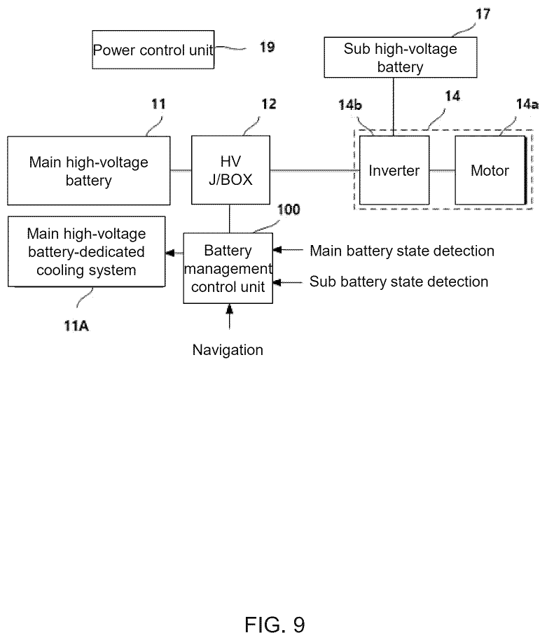

Based on the preceding description, the battery charging and discharging operation system according to an example of the present disclosure may also be applied to another type of dual battery system as shown in FIG. 9. The system of FIG. 9 differs from that of FIG. 2 in that the sub high-voltage battery 17 is connected to the inverter 14b independently of the main high-voltage battery 11, such that a separate high-voltage matching unit 16 is not included.

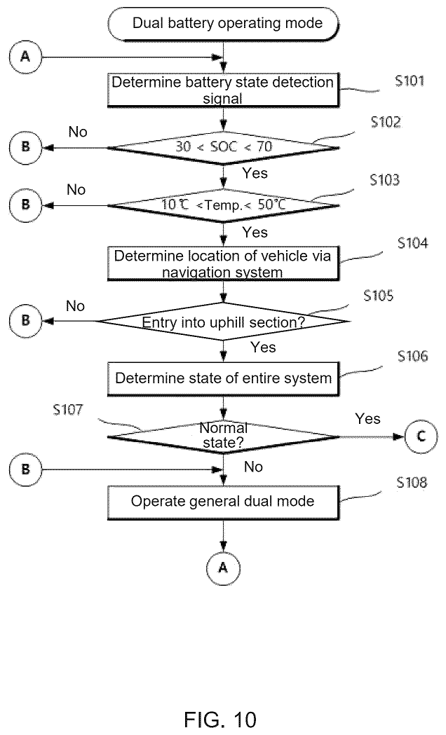

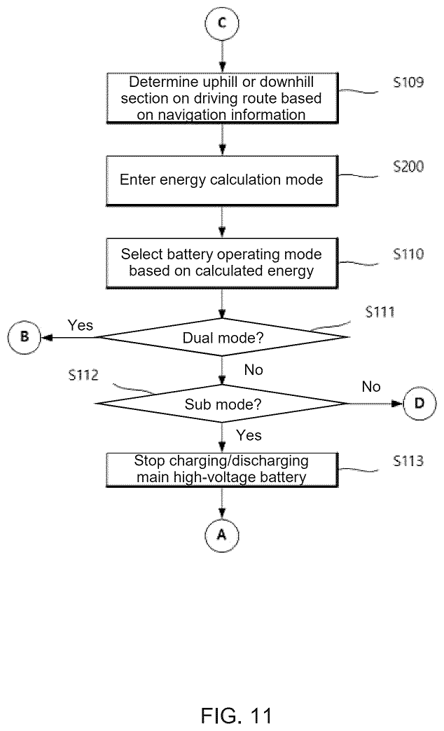

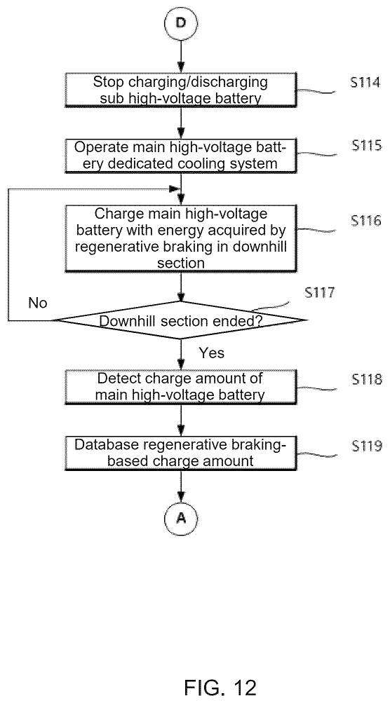

Hereinafter, an operational process of the battery management control unit 100 will be described in detail with reference to the flowcharts shown in FIGS. 10 through 12. For convenience, FIGS. 10-12 are described by way of an example in which the steps are performed by a processor circuit. One, some, or all steps of the example method(s) of FIGS. 10-12, or portions thereof, may be performed by one or more other circuits. One or some, steps of the example method(s) of FIGS. 10-12 may be omitted, performed in other orders, and/or otherwise modified, and/or one or more additional steps may be added.

A battery state (e.g., operating state, temperature, and/or SOC) may be determined (e.g., via the main battery state detection module 110 and the sub battery state detection module 120) (S101).

The battery state comparison recognition module 140 may determine whether the main high-voltage battery 11 and the sub high-voltage battery 17 are both in a normal charge state range (e.g., of SOC 30 to SOC 70, or another preset range of acceptable SOC) (S102).

When/if it is determined that the SOC of the main high-voltage battery 11 and the sub high-voltage battery 17 are in the normal charge state range (S102—Yes), a determination may be made as to whether a current operating temperature of the main high-voltage battery 11 and a current operating temperature of the sub high-voltage battery 17 are both in a normal operating temperature range (e.g., of 10° C. to 50° C., or another acceptable range(s) for proper operation of the respective batteries) (S103).

When/if it is determined that the temperatures of the main high-voltage battery 11 and the sub high-voltage battery 17 are in the normal operating temperature range (S103—Yes), information may be acquired indicating a location of the vehicle and/or a driving route to a destination (e.g., acquired via the navigation information acquisition module 130) (S104).

Based on the acquired information (e.g., navigation information), a determination may be made as to whether there is an uphill section and a downhill section on the driving route. For example, an uphill section and/or downhill section may be identified in the driving route based on altitude/topology information in the navigation information. A determination may also, or alternatively be made as to whether an entry into the uphill section is scheduled/expected (S105).

When/if it is determined that the entry into the uphill section is scheduled/expected (S105—Yes), a state of the entire system may be determined (S106). The entire system may refer to an electrical system excluding the main high-voltage battery 11 and the sub high-voltage battery 17, which may be/comprise the main high-voltage battery-dedicated cooling system 11A, as an example.

A determination may be made as to whether the entire system is in a normal state (S107). When/if it is determined that it is not in the normal state (S107—No), the dual battery system (e.g., of FIGS. 2, 4, 9) may be configured/controlled (e.g., by the battery management control unit 100) to operate a general dual mode (e.g., which uses both the main high-voltage battery 11 and the sub high-voltage battery 17) (S108).

When/if it is determined that the entire system is in the normal state (S107—Yes), information of the driving route, comprising an indication of uphill section(s) and/or downhill section(s) (e.g., a number and/or quantity/length/grade of the uphill section(s) and/or downhill section(s)) present on the driving route, may be determined (S109) (e.g., based on the navigation information). The information of the driving route may also comprise road congestion information and/or weather information.

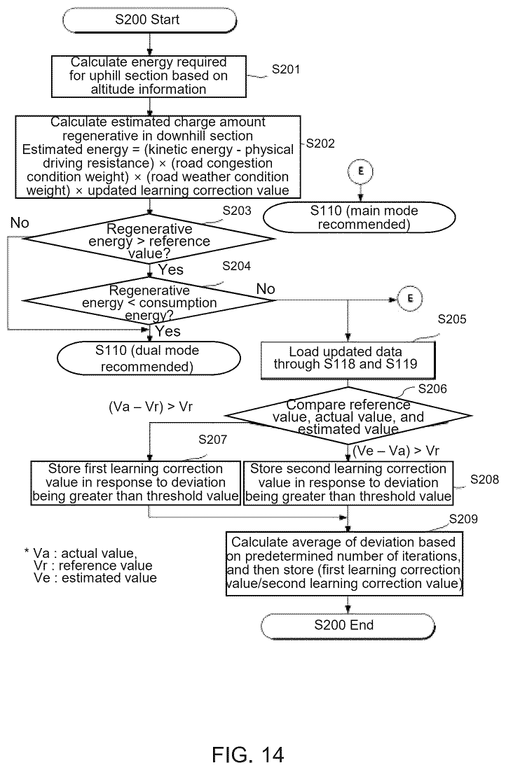

Weights based on the information of the driving route, (e.g., as shown in FIGS. 6 and 7) may be applied/used accordingly to determine/calculate an energy required for the uphill section(s) and/or a regenerative energy that may be acquired in the downhill section(s). Calculation/determination of the estimated energy will be described in detail later (e.g., with respect to FIG. 14).

The battery charging/discharging path setting module 160 may select, based on the estimated energy, one from the dual mode, the main mode, and the sub-mode (e.g., as shown in FIG. 8).

When/if it is determined that the operating mode selected in step S110 is the dual mode (S111—Yes), the dual battery system (e.g., of FIGS. 2, 4, 9) may be configured/controlled (e.g., by the battery management control unit 100) to operate a general dual mode (S108; FIG. 10). When/if it is determined that the operating mode is not dual mode (S111—No), but that the operating mode selected is the sub-mode (S113—Yes), the dual battery system (e.g., of FIGS. 2, 4, 9) may be configured/controlled (e.g., by the battery management control unit 100) to stop charging and discharging the main high-voltage battery 11 and to allow driving using only the sub high-voltage battery 17. The process may return to determine battery state detection signal (S101) and continue as discussed above with respect to FIG. 10.

When/if it is that the operating mode selected in step S110 is the main mode (S111—No; S112—No), the dual battery system (e.g., of FIGS. 2, 4, 9) may be configured/controlled (e.g., by the battery management control unit 100) to stop charging and discharging the sub high-voltage battery 17, and to activate the main high-voltage battery-dedicated cooling system 11A (S115).

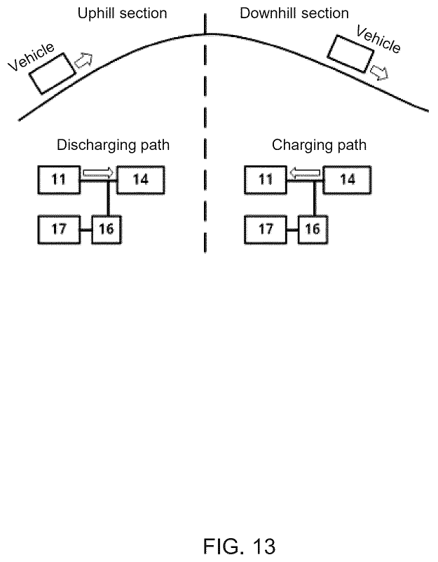

Therefore, the vehicle with the dual battery system may drive in the uphill section using only the main high-voltage battery 11, as shown in FIG. 13, and in the downhill section, only the main high-voltage battery 11 may be charged with an energy acquired by regenerative braking (S116). The vehicle location/elevation/acceleration, etc., may be monitored to determine whether the downhill section has ended (S117). If the downhill section is not determine/detected as ended (S117—No), the main high-voltage battery 11 may continue to be charged with energy acquired by regenerative braking (S116).

When/if it is determined that the downhill section has ended (S117—Yes), total regenerative energy that has been acquired by the regenerative braking in the downhill section may be detected/determined (S118), which may then be data based (e.g., used to update/correct entries in a database (S119).

The process described above may be expected to solve a challenge that involves an increasing loss of the high-voltage matching unit 16 due to repetitions of charging and discharging of the sub high-voltage battery 17, such as in the vehicle with the dual battery system shown in FIG. 4.

It may also be expected that the battery charging and discharging operation method of the dual battery system according to an example of the present disclosure described above may be applied to the vehicle with the dual battery system shown in FIG. 9 (e.g., in which the sub high-voltage battery feeds directly to inverter 14b, and a high-voltage matching unit 16 is omitted).

To increase the efficiency of the battery charging and discharging operation method of the dual battery system and the system therefor, according to an example of the present disclosure described above, the regenerative braking-based charge calculation deep learning module 190 is provided herein.

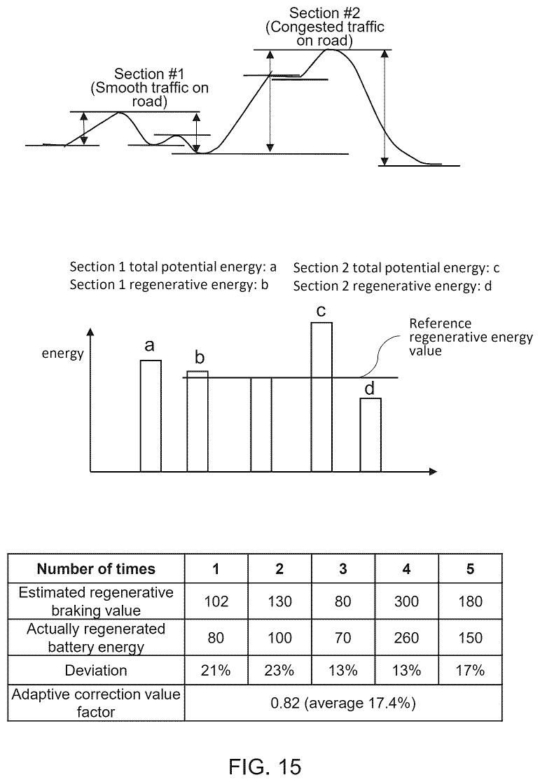

Therefore, the process of step S200 will be described in detail with reference to FIGS. 14 and 15.

FIG. 14 is a flowchart illustrating a process of calculating estimated energy, and FIG. 15 is a diagram illustrating an example of the battery charging and discharging operation system of the dual battery system in a road situation and a downhill situation according to an example. For convenience, FIG. 14 is described by way of an example in which the steps are performed by a processor circuit. One, some, or all steps of the example method of FIG. 14, or portions thereof, may be performed by one or more other circuits. One or some, steps of the example method of FIG. 14 may be omitted, performed in other orders, and/or otherwise modified, and/or one or more additional steps may be added.

An energy required for an uphill section may be calculated based on altitude information of the navigation system (S201).

An estimated total charge amount that can be regenerated in a downhill section (e.g., alternatively referred to as a regenerative energy) may be calculated (S202). An estimated energy may be determined based on the estimated charge amount. For example, the estimated energy may be determined/calculated according to “(kinetic energy-physical driving resistance of the vehicle)*road congestion condition weight*road weather condition weight*updated learning correction value.”

A determination may be made as to whether the regenerative energy satisfies a first threshold (e.g., is greater than a first reference value) (S203). When/if it is determined that the regenerative energy satisfies the first threshold (e.g., is greater than the first reference value) (S203—Yes), it may further be determined whether the regenerative energy satisfies a second threshold (e.g., is less than a consumption energy, which is and/or is based on the amount of energy to be consumed for driving uphill, as in S201) may be determined (S204). When/if it is determined that the regenerative energy does not satisfy the first threshold (S203—No; e.g., is less than or equal to the first reference value) and/or satisfies the second threshold (S204—Yes; e.g., less than the consumption energy), dual mode may be recommended/configured/implemented (S110).

When/if it is determined that the regenerative energy does not satisfy the second threshold (e.g., is not less than the consumption energy) (S204-No), the main mode may be recommended/configured/implemented (S110).

When/if it is determined that the regenerative energy does not satisfy the second threshold (e.g., is not less than the consumption energy), a database may be loaded that is updated as described with respect to the descriptions of S118 and S119.

A second reference value (e.g., the first reference value or any other reference value), an actual value, and an estimated value may be compared (S206). When/if a value acquired from “(energy of actual charge amount-second reference value)” is greater than the second reference value, a first learning correction value may be stored in response to a deviation being greater than a threshold value (S207).

When/if a value acquired in step S206 from “(estimated value—energy of actual charge amount)” is greater than the reference value, a second learning correction value may be stored in response to a deviation being greater than a threshold value (S208).

Subsequently, in step S209, an average value of the deviation (e.g., stored in S207 and/or S208) may be determine/calculated based on a predetermined number of iterations. A value acquired by calculating the first learning correction value with the second learning correction value may be stored (S209).

FIG. 15 shows an example where the energy determined as described herein is applied to a real road. In section 2, energy estimated to be charged by regeneration may be lowered due to a road condition as shown, and in this case, the dual mode may be used without applying the battery charging and discharging operation method of the dual battery system according to an example of the present disclosure.

Therefore, the battery charging and discharging operation method of the dual battery system according to an example of the present disclosure may be applied only to section 1.

A battery charging and discharging operation method in a dual battery system and a system therefor, according to one example of the present disclosure, may, when there are an uphill section and a downhill section on a driving route to a destination in navigation information, calculate an estimated charge amount by regenerative braking acquired in the uphill section; determine whether to drive uphill with only a main high-voltage battery based on the estimated charge amount; and when driving uphill only with the main high-voltage battery, transfer, only to the main high-voltage battery, a charging path by regenerative braking acquired in the downhill section, thereby reducing a system loss that may be caused by charge/discharge of a sub high-voltage battery.

According to at least one example of the present disclosure, there is provided a battery charging and discharging operation method in a dual battery system comprising a navigation system configured to provide a road condition, geographic information, and environmental information of a driving route, a motor system configured to drive a motor, and a main battery and a sub battery each configured to selectively supply power to the motor system, the battery charging and discharging operation method comprising: determining an uphill section and a downhill section on a driving route to a destination set by the navigation system; determining an estimated consumption energy for the uphill section and a regenerative energy for the downhill section; and selecting the main battery and/or the sub battery as a battery to be used for driving in the uphill section and the downhill section.

The determining the uphill section and the downhill section may comprise: acquiring altitude information on the driving route; and determining the uphill section or the downhill section based on the altitude information.

The determining the uphill section and the downhill section may further comprise: acquiring a road condition and a weather condition of the driving route via the navigation system.

The determining the uphill section and the downhill section may further comprise: acquiring a road condition and a weather condition of the uphill section.

The determining the estimated consumption energy may comprise: determining the consumption energy based on the altitude information and the road condition and the weather condition of the uphill section; and determining the regenerative energy based on the altitude information and the road condition and the weather condition of the downhill section.

The selecting may comprise: selecting, based on the consumption energy and the regenerative energy, a dedicated mode to one of the main battery or the sub battery, or a mixed mode of the main battery and the sub battery

The battery charging and discharging operation method may further include: in response to the dedicated mode of using only the main battery being selected, supplying a portion of the consumption energy corresponding to the regenerative energy, using only the main battery; and performing regenerative braking charging to charge the main battery based on the regenerative energy during the downhill section.

The battery charging and discharging operation method may further include: in response to the dedicated mode of using only the main battery being selected, driving a cooling system for cooling the main battery to maintain a constant temperature of the main battery.

The battery charging and discharging operation method may further include: comparing the magnitude of the regenerative energy to an amount of energy charged through the regenerative braking charging; and in response to the amount of energy charged through the regenerative braking charging being smaller than the regenerative energy, improving an output efficiency in the determining the regenerative energy.

The improving of the output efficiency may include improving the output efficiency by deep learning.

According to at least one example of the present disclosure, there is provided a battery charging and discharging operation system of a dual battery system, comprising: a motor system configured to drive a motor; a main battery configured to selectively supply power to the motor system; a sub battery configured to selectively supply power to the motor system; a navigation system configured to provide a road condition, geographic information, and environmental information of a driving route; a power control unit configured to form a charging and discharging path of the main battery and the sub battery in response to a control signal; and a battery management control unit configured to acquire information of the navigation system, information of the main battery, and information of the sub battery, and provide the control signal to the power control unit, wherein the battery management control unit is configured to: determine an uphill section and a downhill section on a driving route to a destination set by the navigation system, determine an estimated consumption energy for the detected uphill section and a regenerative energy for the downhill section, and select the main battery and/or the sub battery as a battery to be used for driving in the uphill section and the downhill section.

The battery management control unit may be configured to: acquire altitude information on the driving route, and determine the uphill section or the downhill section based on the altitude information.

The battery management control unit may be configured to acquire a road condition and a weather condition of the driving route via the navigation system.

The battery management control unit may be configured to acquire a road condition and a weather condition of the uphill section.

The battery management control unit may be configured to: determine the consumption energy based on the altitude information and the road condition and the weather condition of the uphill section, and determine the regenerative energy based on the altitude information and the road condition and the weather condition of the downhill section.

The battery management control unit may be configured to select, based on the consumption energy and the regenerative energy, a dedicated mode to one of the main battery or the sub battery or a mixed mode of the main battery and the sub battery.

The battery management control unit may be configured to: in response to the dedicated mode of using only the main battery being selected, supply a portion of the consumption energy corresponding to the regenerative energy using only the main battery, and charge the main battery based on the regenerative energy during the downhill section.

The battery charging and discharging operation system may further include a cooling system configured to maintain a constant operating temperature of the main battery.

The battery management control unit may be configured to: in response to the dedicated mode of using only the main battery being selected, control the cooling system to maintain the constant temperature of the main battery.

The battery management control unit may be configured to: compare the regenerative energy and an energy charged during the downhill section, and in response to the energy charged during the downhill section being smaller than the regenerative energy, improve an output efficiency.

The battery management control unit may be configured to improve the output efficiency by deep learning.

At least one example of the present disclosure provides a battery charging and discharging operation method in a dual battery system and a system therefor, which may calculate, when there are an uphill section and a downhill section on a driving route to a destination in navigation information, an estimated charge amount by regenerative braking acquired from the downhill section and determine whether to drive uphill only with a main high-voltage battery, and when driving uphill only with the main high-voltage battery, may transfer, only to the main high-voltage battery, a charging path by the regenerative braking acquired from the downhill section, thereby reducing a system loss caused by charge and discharge of a sub high-voltage battery.

While preferred examples of the present disclosure have been shown and described above, the present disclosure is not limited to the specific examples described above, various changes and modifications may be made by one of ordinary skill in the art to which the present disclosure pertains without departing from the spirit and scope of the disclosure, and such changes and modifications should not be construed as being independent of the technical ideas or views of the present disclosure.

What is claimed is:

1. A method performed by a dual battery system of a vehicle, the method comprising:
receiving, from a navigation system of the vehicle, information indicating a driving route and one or more of a road condition of the driving route, geographic information of the driving route, or environmental information of the driving route;
detecting, in the driving route, an uphill section and a downhill section;
determining an estimated consumption energy, of a motor of the vehicle, for the uphill section;
determining an estimated regenerative energy, from regenerative braking of the vehicle, for the downhill section;
selecting, based on the estimated consumption energy and the estimated regenerative energy, at least one battery of a main battery of the vehicle or a sub battery of the vehicle for driving the vehicle in the uphill section and the downhill section; and
controlling charging or discharging of the selected at least one battery during driving of the vehicle in the uphill section and the downhill section.

2. The method of claim 1, further comprising:
acquiring altitude information of the driving route, wherein
the detecting the uphill section or the downhill section based on the altitude information and the driving route.

3. The method of claim 2, further comprising:
acquiring, via the navigation system, the road condition and a weather condition of the driving route.

4. The method of claim 2, further comprising:
acquiring a road condition of the uphill section and a weather condition of the uphill section; and
acquiring a road condition of the downhill section and a weather condition of the downhill section.

5. The method of claim 4, wherein:
the estimated consumption energy is determined based on the altitude information and the road condition of the uphill section and the weather condition of the uphill section; and
the estimated regenerative energy is determined based on the altitude information and the road condition of the downhill section and the weather condition of the downhill section.

6. The method of claim 1, wherein the selecting comprises:
selecting, based on the estimated consumption energy and the estimated regenerative energy, a battery control mode for controlling use of the at least one of main battery and/or the sub battery, wherein the battery control mode is one of:
a first dedicated mode in which the main battery is controlled for use, without the sub battery, in driving the vehicle in the uphill section and the downhill section;
a second dedicated mode in which the sub battery is controlled for use, without the main battery, in driving the vehicle in the uphill section and the downhill section; or
a mixed mode in which both of the main battery and the sub battery are controlled for use in driving the vehicle in the uphill section and the downhill section.

7. The method of claim 6, further comprising:
based on selecting the first dedicated mode:
supplying, via the main battery alone, a portion of consumption energy corresponding to the estimated regenerative energy; and
performing regenerative braking charging to charge the main battery alone based on regenerative energy during the downhill section.

8. The method of claim 7, further comprising:
based on selecting the first dedicated mode, driving a cooling system to maintain a constant temperature of the main battery.

9. The method of claim 7, further comprising:
comparing a magnitude of the estimated regenerative energy to an amount of energy charged via the regenerative braking charging; and
based on the amount of energy charged via the regenerative braking charging being smaller than the estimated regenerative energy, updating a model to improve an output efficiency in determining the estimated regenerative energy.

10. The method of claim 9, wherein the model is a deep learning model.

11. A system for a vehicle, the system comprising:
a motor system comprising a motor and circuitry configured to receive power to drive the motor;
a main battery configured to selectively supply power to the motor system;
a sub battery configured to selectively supply power to the motor system;
a navigation system configured to provide information indicating a driving route and one or more of a road condition of the driving route, geographic information of the driving route, or environmental information of the driving route;
a power controller configured to control, based on a control signal, a charging and discharging path of the main battery and the sub battery; and
a battery management controller configured to acquire information of the navigation system, information of the main battery, and information of the sub battery, and to provide the control signal to the power controller,
wherein the battery management controller is configured to:
detect, in the driving route, an uphill section and a downhill section;
determine an estimated consumption energy for the detected uphill section;
determine an estimated regenerative energy for the downhill section;
select, based on the estimated consumption energy and the estimated regenerative energy, at least one battery of the main battery or the sub battery for driving the vehicle in the uphill section and the downhill section; and
control charging or discharging of the selected at least one battery during driving of the vehicle in the uphill section or the downhill section.

12. The system of claim 11, wherein the battery management controller is configured to:
acquire altitude information of the driving route, and detect, based on the altitude information, the uphill section or the downhill section in the driving route.

13. The system of claim 12, wherein the battery management controller is configured to:
acquire, via the navigation system, the road condition and a weather condition of the driving route.

14. The system of claim 13, wherein the battery management controller is configured to:
acquire a road condition of the uphill section and a weather condition of the uphill section; and
acquire a road condition of the downhill section and a weather condition of the downhill section.

15. The system of claim 14, wherein the battery management controller is configured to:
determine the consumption energy based on the altitude information and the road condition of the uphill section and the weather condition of the uphill section; and
determine the regenerative energy based on the altitude information and the road condition of the downhill section and the weather condition of the downhill section.

16. The system of claim 11, wherein the battery management controller is configured to:
select, based on the estimated consumption energy and the estimated regenerative energy, a battery control mode for controlling use of the at least one of the battery of the main battery and/or the sub battery, wherein the battery control mode is one of:
a first dedicated mode in which the main battery is controlled for use, without the sub battery, in driving the vehicle in the uphill section and the downhill section;
a second dedicated mode in which the sub battery is controlled for use, without the main battery, in driving the vehicle in the uphill section and the downhill section; or
a mixed mode in which the main battery and the sub battery are controlled for use in driving the vehicle in the uphill section and the downhill section.

17. The system of claim 16, wherein the battery management controller is configured to:
based on selecting the first dedicated mode;
supply, via the main battery alone, a portion of consumption energy corresponding to the estimated regenerative energy; and
perform regenerative braking charging to charge the main battery alone based on regenerative energy during the downhill section.

18. The system of claim 17, further comprising:
a cooling system configured to maintain, based on selecting the first dedicated mode, a constant operating temperature of the main battery.

19. The system of claim 17, wherein the battery management controller is configured to:
compare the estimated regenerative energy and an energy charged during the downhill section; and
based on the energy charged during the downhill section being smaller than the estimated regenerative energy, updating a model to improve an output efficiency in determining the estimated regenerative energy.

20. A vehicle comprising:
a motor;
circuitry configured to receive power to drive the motor;
a main battery configured to selectively supply power to the motor;
a sub battery configured to selectively supply power to the motor;
a navigation system configured acquire a driving route for the vehicle;
a power controller configured to control, charging or discharging of the main battery or the sub battery; and
a battery management controller configured to:
receive, from the navigation system, the driving route,
determine, based on an uphill section and a downhill section detected in the driving route:
an estimated consumption energy for the uphill section, and
an estimated regenerative energy for the downhill section;
select, based on the estimated consumption energy and the estimated regenerative energy, the main battery or the sub battery; and
send, to the power controller, a control signal configured to control charging and discharging of the select battery during driving of the vehicle on the uphill section and the downhill section.
